(19) United States
(12) Patent Application Publication
(10) Pub. No.: US 2003/0034753 A1
(43) Pub. Date: Feb. 20, 2003

(54) Constant torque AC induction motor controller

(76) Inventors: Ashley R. Heimbaugh, Plymouth, MI (US); Susan Heimbaugh, Plymouth, MI (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 09/928,595

(22) Filed: Aug. 14, 2001

(51) Int. Cl. H02P 1/24; H02P 1/42; H02P 3/18; H02P 5/28; H02P 7/36

(52) U.S. Cl. 318/727

(57) ABSTRACT

A constant torque alternating current (AC) induction motor controller adapted to be attached to machine tools uses a power factor controller. With induced EMF sensing, the controller provides enhanced “soft” starting of the motor.

### BACKGROUND OF THE INVENTION

The present invention relates generally to induction motor controllers and, in particular, to a constant torque alternating current (AC) induction motor controller adapted to be attached to machine tools.

Induction motors, motors in which the stator's rotating magnetic field makes the rotor revolve, are well known. AC induction motors are also well known, and are commonly used as the prime mover in machine tool applications. Wear and stress on the machine tools is often directly related to the operating parameters of the motor by which they are driven. AC induction motors are “constant-speed” drives and a controller is typically connected to the motor in order to provide two or more speeds or an adjustable range of speeds.

On initial startup, a typical prior art AC induction motor, regardless of its size, draws six to eight times its full load amperage to overcome the initial torque required to bring the motor to its designed operating speed. In addition, most prior art AC induction motors operate at excessive power requirements when not under load or when under low torque requirements. This excessive power or torque creates undue stress on the coupled machine components and is also wasted power, in the form of excess heat, from the motor. AC induction motors are typically designed for a maximum number of allowable starts over a given period of time. When the number of designed starts are exceeded, the motor begins to overheat, reducing the life of the motor.

Furthermore, prior art AC induction motors of smaller horsepower (those motors of 25 horsepower or less) typically operate at low efficiency levels because of the inherent design characteristics of the motors. The low efficiency levels results in excessive heat buildup in the motor, which is also wasted power.

It is desirable to provide a controller for AC induction motors that will provide constant torque to the coupled AC induction motor utilized in a machine tool application. It is also desirable to provide a controller for AC induction motors utilized in a machine tool application that will reduce the starting current required for the coupled AC induction motor, that will reduce the starting stresses on the coupled machine components, that will increase the life of the coupled machine components, and that will reduce the cutting stresses on the cutting tool and the coupled drive components. Furthermore, it is desirable to provide a controller for AC induction motors utilized in a machine tool application that will reduce the cutting trauma to the machined part, which will correspondingly increase the quality of the machined component. It is also desirable to provide a controller for AC induction motors utilized in a machine tool application that will reduce machine tool downtime due to tool failure, and that will provide for a better finished machined part with less trauma to the finished part.

### SUMMARY OF THE INVENTION

The present invention concerns a constant torque alternating current (AC) induction motor controller for an AC induction motor adapted to be attached to machine tools. Many manufacturing processes require metal cutting of products in some form such as turning, planing, milling, drilling, etc. A typical machine tool moves either or both the product and a “cutter” relative to one another to remove a desired amount of metal from a desired location on the product. The movable portion of the machine tool can be connected directly to the output shaft of the induction motor, or indirectly via a transmission device such as gears or drive belts/pulleys. In many machining operations, the production of constant torque by the AC induction motor provides many benefits to the quality of the product and the life of the machine tool.

From the U.S. Pat. No. 4,459,528 issued to Nola, which is herein incorporated by reference, a phase detector for a three-phase power factor controller is known that includes a plurality of electronic switching means individually connected between the respective phase terminals of a three-phase voltage supply line and the corresponding phase windings of the motor. The '528 patent also includes phase detection means attached to each phase of a three-phase power supply for detecting the motor voltage and current in each phase and for producing, for each phase an output proportional to the phase difference between the motor voltage and current. The '528 patent also includes summing means for summing the outputs of the outputs of the phase detector means; power factor command signal generating means for generating a power factor command signal; and control means, responsive to the output of the summing means and to the power factor command signal, for controlling switching of the switching means. The individual phase detector means of the controller each include means, comprising an operational amplifier whose inputs are connected across the corresponding electronic switching means for that phase, for sensing the current phase angle for that phase by sensing the voltage across the corresponding switching means, and generally concerns the provision of means providing positive feedback between the output and input of the operational amplifier such that switching of the output of the operational amplifier is synchronized with switching of the voltage across the electronic switching means.

From the U.S. Pat. No. 4,433,276 issued to Nola, which is herein incorporated by reference, a three-phase power factor controller is known that is particularly adaptable for employment with three phase motors wherein there is not available a terminal common to all phases. A power factor, or phase detector, is employed for each of the phases of a three-phase induction motor, and the detected values are summed to effect a composite signal, and this signal is used as a basis of control. The signal is subjected to signal conditioning, including signal integration, and employed to control the turn-on time of each of three thyristors coupling power to the motor.

From the U.S. Pat. No. 4,469,998 issued to Nola, which is herein incorporated by reference, a three-phase power factor controller with induced electromotive force (emf) sensing is known that includes comprising electronic switching means (e.g. a thyristor) connected in series with the motor, phase detector means for sensing the motor current and voltage and providing an output proportional to the phase difference between the motor voltage and current; a command signal generating means for generating a power factor command signal; and a control means, responsive to the output of phase detector means and the power factor command signal, for controlling the switching state of the electronic switching means; and, in general, comprises the provision of means for sensing the induced emf produced by the motor during the time interval in each half cycle when the electronic switching means is in the off state thereof and for producing, in accordance with the induced emf sensed thereby, a feedback signal for use in controlling switching of the electronic switching means. The sensing means preferably senses polarity reversals in the motor voltage waveform caused by loading of the motor and includes a high gain operational amplifier whose output is blocked except during the interval in each half cycle when the induced emf produced during the “off” period of the switching means is of opposite polarity to the voltage during the “on” period of the switching means.

The present invention recognizes that the phase detector and power factor controllers of the '528 , '276, and '998 patents may be adapted to be used in a novel manner in the field of machine tools applications.

By the use of the prior art phase detector and power factor controllers, the present invention reduces the starting current by as much as 80 percent, providing a true “soft-start” for the motor. This reduction in starting current reduces both the heat buildup in the motor and the starting stresses on the coupled machine components, which results in increased life of both the motor and machine tool.

After the present invention starts the motor, and the motor has reached at its design operating rpm, the present invention utilizes the prior art phase detector and power factor controllers to continually optimize the motor's power requirements. This method of continuous control minimizes the energy wastage caused by overfluxing the motor. This results in a significant reduction in the kilovolt-ampere (kVA) demand of the motor, eliminating wasted energy in the form of heat and in reduced kilowatt (kW) and kilowatt-hour (kW-hr) consumption. While the motor is operating, the motor delivers the torque demanded, but the present invention allows the motor to draw only the precise amount of magnetizing current required to support the torque output. This is a great improvement over prior art controllers, which allowed the motor to draw only the maximum amount of current regardless of the load.

The present invention also overcomes the problems of low efficiency noted in AC induction motors of 25 horsepower or less by reducing operating temperatures as much as 15 to 20 degrees Celsius. This increase in efficiency can double the effective life of the induction motor, in addition to the benefits of fully optimizing the characteristics of the motor to which the present invention is connected, noted above.

The use of the present invention produces additional benefits for the coupled machine components because of reduced stress of operating constantly at maximum torque. Belts, pulleys, gears, bearings, and cutting tools, for example, will all benefit from a prolonged effective life with the use of the present invention.

The present invention allows an AC induction motor to run smoother, allowing, in turn, the coupled machine tool to run smoother. The controller thus extends the life of the cutting tools, advantageously reducing cutting chatter, and ultimately produces a better-finished product.

The present invention also contemplates use of single and three-phase AC induction motors, running at 50 or 60 Hertz, and preferably at AC voltages ranging from 100 Volts to 600 Volts, although higher voltage motors may also benefit from the use of the present invention.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a schematic block diagram of a machine tool system including a constant torque AC induction motor controller in accordance with the present invention; and

FIG. 2 is a schematic block diagram of the power factor controller shown in FIG. 1.

### DESCRIPTION OF THE PREFERRED EMBODIMENT

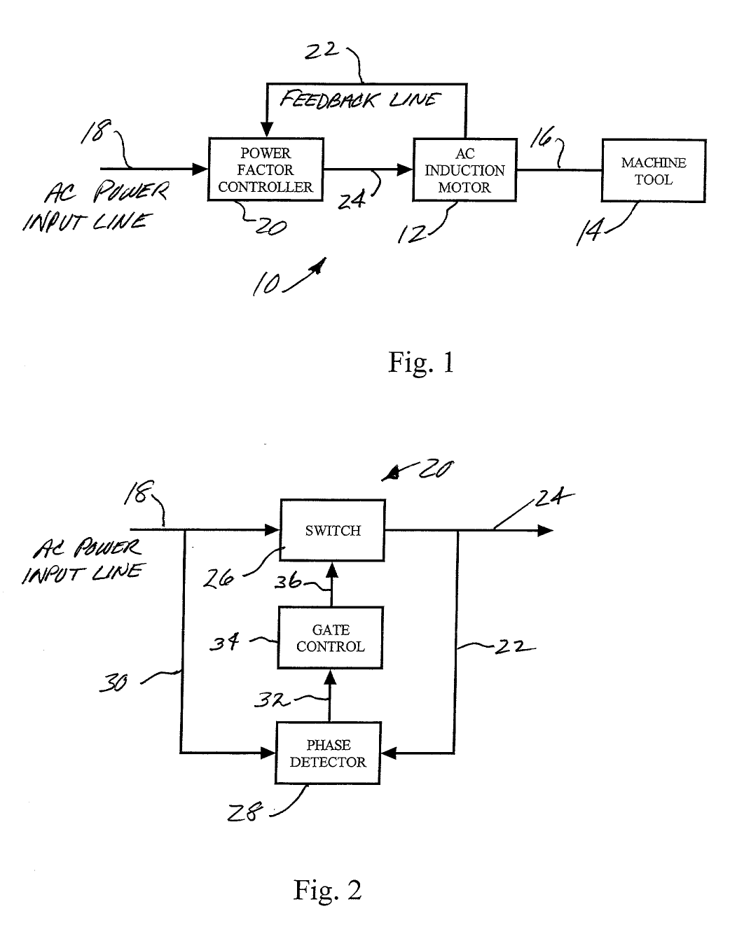

Referring now to FIG. 1, there is shown a machine tool system 10 including an AC induction motor 12 coupled to drive a machine tool 14 through a transmission device 16. The motor 12 is provided with AC power from an AC power input line 18, which power may be three-phase or single-phase AC power. The AC power input line 18 typically supplies voltage at 50 or 60 Hertz in a range of 100 Volts to 600 Volts.

The input line 18 is connected to one input of a controller means 20 having another input connected to the AC motor 12 by a feedback line 22. An output of the controller means 20 is connected to deliver electrical power over a line 24 to an input of the AC induction motor 12. As shown in FIG. 2, the controller means 20 includes a switch 26 connected between the lines 18 and 24 for controlling the flow of current to the motor 12. A phase detector 28 has one input connected to the input line 18 by a line 30 and another input connected to the line 24 by the feedback line 22. An output of the phase detector 28 is connected by a line 32 to an input of a gate control 34. An output of the gate control 34 is connected by a line 36 to another input of the switch 26. The switch 26 can be any suitable power control device such as a thyristor.

The controller means 20 is a power factor controller as described in the U.S. Pat. Nos. 4,459,528, 4,446,998, and 4,433,276 to produce a constant torque output from the motor 12 and enhance “soft” starting of the motor. The controller means 20 functions to control the turn-on time of the switch 26. The switch 26 is controlled to produce the amount of current required to produce the torque matching the load generated by the machine tool 14. Thus, the controller means 20 maintains rated motor RPM while changing the torque output to match the load.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A machine tool system comprising:
a machine tool;
an AC induction motor connected to drive said machine tool; and
a power factor controller means connected to said AC induction motor for operating said AC induction motor at rated RPM with a torque output to said machine tool matching a load imposed by said machine tool.

2. The machine tool system according to claim 1 wherein said power factor controller is provided with AC power at 50 Hertz.

3. The machine tool system according to claim 1 wherein said power factor controller is provided with AC power at 60 Hertz.

4. The machine tool system according to claim 1 wherein said power factor controller is provided with single phase AC power.

5. The machine tool system according to claim 1 wherein said power factor controller is provided with three phase AC power.

6. The machine tool system according to claim 1 wherein said power factor controller is provided with AC power in a range of 100 to 600 volts.

7. The machine tool system according to claim 1 wherein said power factor controller is a three phase power factor controller.

8. The machine tool system according to claim 1 wherein said power factor controller is a three phase power factor controller with induced EMF sensing.

9. A machine tool system comprising:
a machine tool;
a three phase AC induction motor connected to drive said machine tool; and
a three phase power factor controller means connected to said AC induction motor for operating said AC induction motor at rated RPM with a torque output to said machine tool matching a load imposed by said machine tool.

10. A machine tool system comprising:
a machine tool;
a three phase AC induction motor connected to drive said machine tool; and
a three phase power factor controller means with induced EMF sensing connected to said AC induction motor for operating said AC induction motor with enhanced “soft” starting.
